(19) United States
(12) Patent Application Publication
(10) Pub. No.: US 2006/0271791 A1
(43) Pub. Date: Nov. 30, 2006

(54) Method and system for biometric based access control of media content presentation devices

(75) Inventors: Brian M. Novack, St. Louis, MO (US); Daniel L. Madsen, Castro Valley, CA (US); Michael D. Cheaney, Arnold, MO (US); Timothy R. Thompson, Wentzville, MO (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/140,145

(22) Filed: May 27, 2005

(51) Int. Cl. H04K 1/00; H04L 9/00

(52) U.S. Cl. 713/186

(57) ABSTRACT

A centralized biometric system for verifying the identity of a user over a communications network includes a device that stores biometric information in association with information that identifies users. The system further includes a receiver that receives, from a media content presentation device via a communications network, a biometric sample provided by a user requesting media content from a provider. The provider delivers the media content requested by the user from the communications network to the media content presentation device for receipt by the user contingent upon the identity of the user being verified. The system further includes a processor that compares the biometric sample provided by the user to stored biometric information of the user. The processor verifies the identity of the user upon a sufficient correspondence between the biometric sample provided by the user and the stored biometric information of the user.

### BACKGROUND OF THE INVENTION

1. Field of the Invention

The present invention generally relates to controlling access to media content presentation devices.

2. Background Art

Service providers deliver media content to users via media content presentation devices. For example, cable and satellite television providers deliver media content such as television programming to users via set-top boxes (STB) (such as cable and satellite television receivers, digital video recorders (DVR), etc.). Satellite radio providers deliver media content such as radio programming to users via satellite radio receivers. Providers deliver media content such as video programming to users via media content presentation devices such as television tuners, video cassette recorders (VCR), etc.

Often, a provider delivers media content requested by a user to the user upon performing some sort of identify verification of the user. User identity verification is intended to assure that a user requesting media content is indeed the user. Upon verifying the identity of a user requesting media content, a provider determines whether the user is authorized to receive the media content. If the user is authorized, then the provider delivers the requested media content to the user via the user's media content presentation device.

User identity verification benefits both users and providers. Providers will not deliver media content to users until at least performing some sort of user identity verification. Providers typically charge fees to users for delivering media content to the users. Thus, providers will charge users with fees for delivering media content to individuals posing as the users. As a result, it is beneficial that providers do not deliver media content to individuals posing as users. Further, some media content is not appropriate for all users. As a result, it is beneficial that providers do not deliver media content (such as violent images) to individuals posing as users in which the media content is not appropriate for the individuals (such as children).

One method for verifying the identity of a user involves the use of a personal identification number (PIN). In this method, a user provides a PIN to a provider when requesting media content from the provider. If the PIN provided by the user corresponds to a PIN previously registered by the provider for the user, then there is some assurance that the user providing the PIN is actually the user and not an individual posing as the user. The provider uses the PIN provided by the user as authorization from the user to deliver the requested media content to the user. The provider may check its own registered information about the user (whether the user has paid previous fees for media content, whether the user is restricted from receiving certain media content, etc.) to determine whether the user is authorized to receive the requested media content from the provider. If the provider determines the user to be an authorized user for the requested media content, then the provider delivers the requested media content via a media content presentation device to the user.

The PIN is typically a four digit number or the like. An example of a user using a PIN when requesting media content from a provider involves a cable television user entering the user's PIN on the user's television remote control. The remote control communicates the entered PIN to the user's STB. The STB communicates the entered PIN to the provider (which, in this example, is a cable television provider). The provider delivers the requested media content to the user's STB for the user upon verifying that the entered PIN corresponds to a registered PIN for the user and verifying that the user is authorized to receive the requested media content.

A problem with verifying the identity of a user based on a PIN is that it is easy for individuals to obtain the user's PIN. For instance, in the example above, the authorized user is a parent and unauthorized users are children in the household. It is easy for the children to gain access to the parent's PIN by simply watching the parent work the remote control.

### BRIEF DESCRIPTION OF THE DRAWINGS

FIG. 1 illustrates a communications network architecture for centralized biometric authentication of users requesting media content in accordance with the present invention;

FIG. 2 illustrates the verification system of the communications network architecture for centralized biometric authentication of users requesting media content shown in FIG. 1; and

FIG. 3 illustrates a flow diagram describing a method of centralized biometric authentication of users requesting media content in accordance with the present invention.

### DETAILED DESCRIPTION OF THE PREFERRED EMBODIMENT(S)

The method and system for biometric based access control of media content presentation devices in accordance with the present invention has many advantages. The method and system satisfy the need to securely authenticate a user of a media content presentation device in order to control the delivery of media content from a service provider to the user via the media content presentation device. That is, the method and system enable a provider to verify the identity of a user prior to delivering requested media content to the user. User identity verification is intended to assure that a user requesting media content is indeed the user. The provider determines whether a user requesting media content is authorized to receive the media content after verifying the identity of the user.

In accordance with the method and system of the present invention, user identity verification includes comparing biometric information provided by a user at the time the user requests media content with biometric information previously registered for the user. Biometric information of a user includes fingerprints, voice characteristic information, facial geometry, DNA, iris scan information, etc. which are used to verify the identity of the user. A provider treats a user's action of providing biometric information at the time of requesting media content as authorization from the user to accept the requested media content. If biometric information provided by a user corresponds to biometric information previously registered for the user, then the identity of the user is verified (i.e., the provider is assured that the user is indeed the user). If biometric information provided by a user does not correspond to biometric information previously registered for the user, then the identity of the user is not verified.

Thus, the method and system securely authenticate a user requesting media content based on biometric information of the user. Authenticating a user requesting media content based on user biometric information provides a relatively strong claim to the identity of the user. That is, user biometric information provides a relatively great amount of assurance that the user is indeed the user and is not an imposter. In this way, a provider or a user such as a parent can have confidence that the media content being provided is in fact being received by individuals that are authorized to receive the media content.

Thus, the method and system provide a solution to the need of securely authenticating a user of a media content presentation device in order for a provider to control delivery of media content requested by the user to the user via the media content presentation device. As a result, the method and system provide a way for cable and satellite television providers to securely authenticate users in order for these providers to control the delivery of television programming to users via STBs. Likewise, the method and system provide a way for satellite radio providers to securely authenticate users in order for these providers to control the delivery of radio programming to users via satellite radio receivers. Likewise, the method and system provide a way for providers to securely authenticate users in order for these providers to control the delivery of media content such as video programming to users via media content presentation devices such as television tuners, video cassette recorders (VCR), etc.

According to an aspect of the present invention, the present invention provides a centralized biometric system for verifying the identity of a user over a communications network. The system includes a storage that stores biometric information in association with information that identifies users. The system includes a receiver that receives, from one of a media content presentation device and an associated input device via the communications network, a biometric sample of a user requesting media content from a provider. The system includes a processor that compares the biometric sample to the stored biometric information to authenticate the identity of the user. The provider delivers the media content requested by the user to the media content presentation device for the user contingent upon authentication of the user as being the user.

According to another aspect of the present invention, the receiver receives multiple media content requests from users via multiple media content presentation devices that are each operable to provide media content delivered by providers to the users. The multiple media content requests of the users are respectively accompanied with biometric samples of the users.

According to an aspect of the present invention, the present invention provides a method for verifying the identity of a user over a communications network using a centralized biometric system. The method includes storing biometric information in association with information that identifies users. The method includes receiving, from one of a media content presentation device and an associated input device via the communications network, a biometric sample of a user requesting media content from a provider. The method includes comparing the biometric sample to the stored biometric information to authenticate the identity of the user. The provider delivers the media content requested by the user to the media content presentation device for the user contingent upon authentication of the user as being the user.

According to another aspect of the present invention, multiple media content requests from users are received via multiple media content presentation devices that are each operable to provide media content delivered by providers to the users. The multiple media content requests of the users are respectively accompanied with biometric samples of the users.

According to an aspect of the present invention, the present invention provides a computer readable medium for storing a program that verifies the identity of a user over a communications network using a centralized biometric system. The computer readable medium includes a biometric storing code segment that stores biometric information in association with information that identifies users. The computer readable medium includes a receiving code segment that receives, from one of a media content presentation device and an associated input device via the communications network, a biometric sample from a user requesting media content from a provider. The computer readable storage medium includes a comparing code segment that compares the biometric sample to the stored biometric information to authenticate the identity of the user. The provider delivers the media content requested by the user to the media content presentation device for the user contingent upon authentication of the user as being the user.

According to another aspect of the present invention, multiple media content requests from users are received via multiple media content presentation devices that are each operable to provide media content delivered by providers to the users. The multiple media content requests of the users are respectively accompanied with biometric samples of the users.

The present invention further provides a communications system for authenticating the identity of a user requesting media content using centralized biometric authentication. The communications system is part of the communications network and includes a media content presentation device and a verification system. As used herein, the user may be an individual, e.g., a customer or a subscriber, using a media content presentation device to request and obtain media content from a provider supported via the communications network.

In an embodiment, the communications network is a cable television network that delivers media content (such as television programming) from a cable television provider to users via media content presentation devices (such as STBs) of the users. The cable television provider delivers television programming requested by the users to the users via the cable television network and the STBs contingent upon biometric information provided by the users corresponding to stored biometric information that identifies the users.

In an embodiment, the communications network is a satellite television network that delivers media content (such as television programming) from a satellite television provider to users via media content presentation devices (such as STBs) of the users. The satellite television provider delivers television programming requested by the users to the users via the satellite televison network and the STBs contingent upon biometric information provided by the users corresponding to stored information that identifies the users.

In an embodiment, the communications network is a satellite radio network that delivers media content (such as radio programming) from a satellite radio provider to users via media content presentation devices (such as satellite radio receivers) of the users. The satellite radio provider delivers radio programming requested by the users to the users via the satellite radio network and the satellite radio receivers contingent upon biometric information provided by the users corresponding to stored information that identifies the users.

The verification system receives the biometric samples from the media content presentation devices and/or the associated input devices via the communications network and authenticates the biometric samples as originating from the users. The verification system may be implemented in a distributed manner. For example, a communications network may include a centralized processor that retrieves data from distributed databases. Alternatively, the communications network may include a centralized processor that receives media content requests from users, analyzes the requests (and associated biometric information), and forwards the requests to secondary processors according to the type of information being processed.

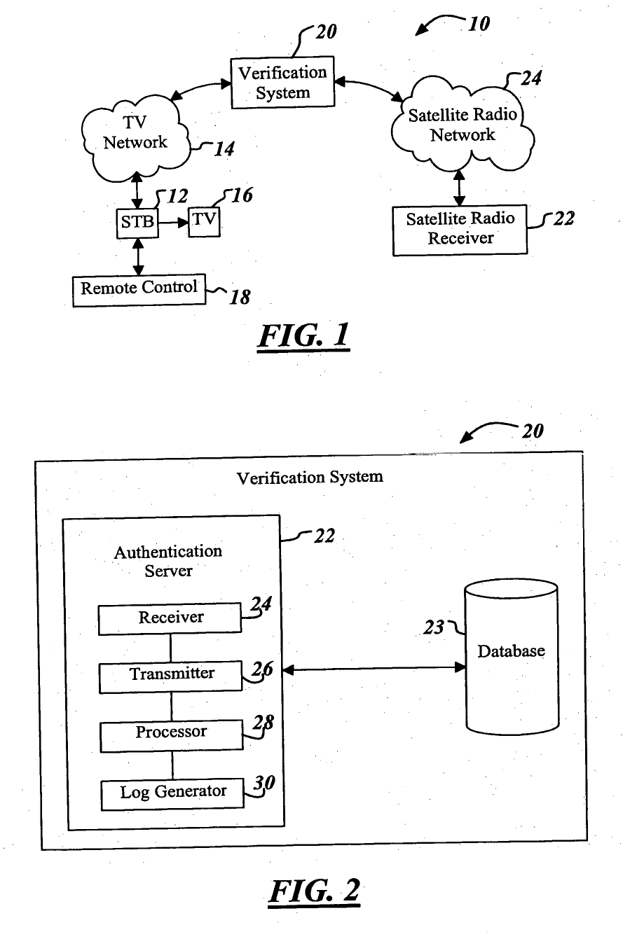

Referring now to FIG. 1, a communications network architecture 10 for centralized biometric authentication of users requesting media content in accordance with the present invention is shown. As shown, an individual media content presentation device is an STB 12 in communication between a television (TV) network 14 and a TV 16. TV network 14 is associated with a TV provider and TV 16 is associated with a user. The TV provider may be a cable or satellite TV provider. The TV provider delivers media content such as TV programming from TV network 14 to STB 12. In turn, STB 12 directs TV 16 to output the media content for the user. The user uses an input device such as a remote control 18 to communicate with STB 12 in order to control TV 18 and to communicate with the TV provider via TV network 14. The user uses remote control 18 to communicate requests for media content to STB 12 for receipt by the TV provider. The TV provider is operable to deliver requested media content from TV network 14 to STB 12 for the user in response to the user's requests.

In accordance with the present invention, the TV provider delivers media content requested by the user to STB 12 for the user upon the identity of the user being verified based on biometric information. More particularly, the TV provider delivers media content requested by the user to STB 12 for the user contingent upon authentication of the user. The user is authenticated as the user upon a biometric sample provided by the user at the time of making the request for the media content corresponding to stored biometric information that identifies the user. The user provides the biometric sample to one of STB 12 and remote control 18 at the time of making the media content request or at a time afer making the media content request in response to an invitation from the TV provider to provide the biometric sample.

STB 12 and/or remote control 18 are configured to receive biometric samples from the user. For example, the biometric sample of the user may be a fingerprint of the user. In this case, STB 12 and/or remote control 18 have a fingerprint reader for obtaining the fingerprint of the user. As another example, the biometric sample of the user is voice characteristic information of the user. In this case, STB 12 and/or remote control 18 have a microphone for obtaining voice characteristic information of the user. As another example, the biometric sample of the user is the facial geometry of the user. In this case, STB 12 and/or remote control 18 have a camera for taking a picture of the user's face. As another example, the biometric sample of the user is iris scan information. In this case, STB 12 and/or remote control 18 have a camera for taking a picture of the user's eyes. As another example, the biometric sample is DNA. In this case, STB 12 and/or remote control 18 have an apparatus for taking a sample of the user's hair, skin, blood, saliva, etc.

As such, the biometric input device (such as a fingerprint reader) is dependent on the particular biometric employed. Thus, the biometric input device can be integrated in the media content presentation device, an input device (such as a remote control) for the media content presentation device, removable media (such as a USB storage device), or stand alone by itself.

Upon receiving a biometric sample from the user, remote control 18 converts the biometric sample into a signal and then communicates the biometric sample signal to STB 12. STB 12 then communicates the biometric sample signal along with the user's request for media content (if not previously communicated) to the TV provider via TV network 14. Likewise, upon receiving a biometric sample directly from the user, STB 12 converts the biometric sample into a signal and then communicates the biometric sample signal along with the user's request for media content (if not previously communicated) to the TV provider via TV network 14.

The TV provider then provides the biometric sample signal to a verification system 20. Verification system 20 stores biometric information in association with information that identifies a plurality of users. As such, verification system 20 is a centralized biometric system for verifying a user's identity over a communications network. In this case, the communications network includes STB 12 and TV network 14. Verification system 20 includes a processor that compares the biometric sample to the stored biometric information of the user. If the biometric sample corresponds to the stored biometric information of the user, then verification system 20 authenticates the user as being the user. If the biometric sample does not correspond to the stored biometric information of the user, then verification system 20 does not authenticate the user.

If verification system 20 authenticates the user as being the user, then the TV provider delivers the requested media content to STB 12 for the user. Likewise, if verification system 20 determines that the user is not the registered user (i.e., does not authenticate the user), then the TV provider does not deliver the requested media content to STB 12. Accordingly, communications network architecture 10 enables centralized biometric authentication so that the functionality of verification system 20 can be used to enhance the media content services provided by the TV provider to users.

TV 16 may be configured such that the TV is equipped with a device that performs the functions of STB 12. In this case, a device such as STB 12 is integrated with TV 16 and the integrated TV communicates directly with TV network 14. TV 16 may be configured to receive biometric samples directly from the user or indirectly from the user via remote control 18. In either case, TV 16 provides the received biometric samples to STB 12 for communication to verification system 20 via TV network 14 or the integrated TV directly provides the received biometric samples to the verification system via the TV network. It is also noted that a biometric sample reader separate from STB 12, TV 16, and remote control 18 may be provided for receiving biometric samples directly or indirectly from the user. In this case, the biometric sample reader provides received biometric samples directly to verification system 20 without any intervening device or network, indirectly to the verification system via TV network 14, indirectly to the verification system via the TV network and one of STB 12 and integrated TV 16, etc.

In an alternative embodiment, an individual media content presentation device is a satellite radio receiver 22 in communication with a satellite radio network 24. Satellite radio network 24 is associated with a satellite radio provider and satellite radio receiver 22 is associated with a user. The satellite radio provider delivers media content such as radio programming from satellite radio network 24 to satellite radio receiver 22. In turn, satellite radio receiver 22 outputs the media content for the user. The user uses satellite radio receiver 22 to communicate with the satellite radio provider via satellite radio network 24. The user communicates requests for media content to the satellite radio provider using satellite radio receiver 22. The satellite radio provider is operable to deliver requested media content from satellite radio network 24 to satellite radio receiver 22 for the user in response to the user's requests.

In accordance with the present invention, the satellite radio provider delivers media content requested by the user to satellite radio receiver 22 for the user upon the identity of the user being verified based on biometric information as described above. To this end, satellite radio receiver 22 is configured to receive biometric samples from the user as described above.

In an embodiment, networks such as TV network 14 and satellite radio network 24 may include an intelligent peripheral that provides responses to and receives instructions from a control point (not shown). The control point processes data from the communications received from the users via the media content presentation devices and determines the responses to provide to the users via the media content presentation devices. The networks process communications received from users according to a script. The communications flow may vary depending on the information provided by the users. The communications flow proceeds until the networks determine that the identities of users needs to be verified, at which time the networks contact verification system 20 as part of the script. As an example, the networks contact verification system 20 as a result of users requesting media content that requires authentication of the identity of the users. During this contact, the networks provide the biometric sample received from the users to verification system 20. Subsequently, verification system 20 informs the networks of the verification results.

The networks and verification system 20 interact until the verification system determines whether the identity of the users can be established. The networks and verification system 20 communicate with one another through other communication networks such as the internet, wide area networks, local area networks, wireless networks, etc. In an embodiment, verification system 20 may only accept communications directly from the networks (i.e., TV network 14 and satellite radio network 24) such that a user is blocked from directly communicating with verification system 20.

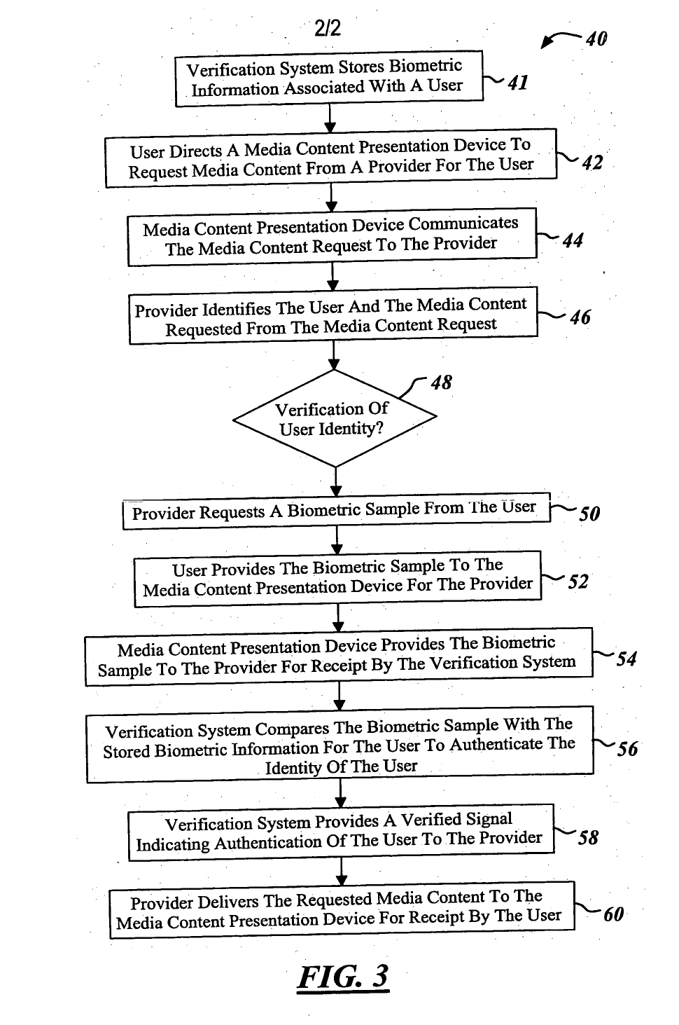

Referring now to FIG. 2, with continual reference to FIG. 1, verification system 20 of communications network architecture 10 for centralized biometric authentication of users requesting media content is shown in greater detail. Verification system 20 includes an authentication server 22 that processes communications from the providers. Again, the communications from the providers generally includes biometric sample signals provided by users requesting media content and any other information that would be useful to authenticate the users as desired by the providers.

Verification system 20 includes a database 23 that stores biometric information in association with information that identifies users. For example, database 23 stores at least one of pre-registered fingerprints, voice characteristic information, facial geometries, iris scan information, DNA, etc. for users. Authentication server 22 retrieves the stored biometric information for a user requesting media content and compares the biometric sample of the user as received from the provider. The identity of user requesting media content is authenticated when the comparison results in a determination that the biometric sample bears adequate similarities to the biometric information stored for the user.

As described above, authentication server 22 generally communicates with a provider such as TV provider 14 via a network such as TV network 14. To this end, authentication server 22 includes a receiver 24. Receiver 24 receives biometric sample signals of users from TV network 14. Again, the users input the biometric samples to media content presentation devices and/or input devices. Authentication server 22 includes a transmitter 26. Transmitter 26 communicates user verification identity signals to the provider. The verification identity signals generally indicate that a user is authenticated as being the user or not. Based on the verification identity signals, the provider can decide whether to deliver media content requested by a user to the user.

Verification system 20 includes a processor 28. Processor 28 processes the biometric sample signals of users requesting media content as received by receiver 24 and accesses database 23 to access the stored biometric information for the users. Processor 28 then compares the biometric sample of each user with the stored biometric information of the user to determine whether the biometric sample of the user corresponds to the stored biometric information of the user. If there is a sufficient correspondence between a biometric sample of a user requesting media content and the biometric information stored for the user, then processor 28 authenticates the identity of the user. For example, processor 28 may authenticate the identity of a user requesting media content based on a scoring system. For instance, processor 28 authenticates the user if the biometric sample of the user and the biometric information stored for the user have a confidence level appropriate for the task and/or biometric category. Processor 28 then provides user verification identity signals indicative of user authentication (or lack thereof) to transmitter 26.

Authentication server 20 further includes a log generator 30. Log generator 30 stores information related to an authentication attempt. Log generator 30 generates information including user requests for media content that can then be used to support audit efforts. For example, log generator 30 may store information that indicates who a provider expects to be identified, e.g., “John Smith, account number 64747.” Log generator 30 may also store information regarding positive and negative authentication attempts of the users along with date, time, requested content, and other relevant information.

Accordingly, verification system 20 provides a centralized service to support the use of biometric technology to enable identification, authentication, and/or authorization of a user requesting media content from a provider. Although not described for each separate type of biometric, the biometric information may include voice, fingerprint, retina, genetic, facial, hand, palm, handwriting, iris, physical geometric techniques, and/or any other identifying characteristic that is used to identify individual users. As described above, a person attempting to obtain media content from a provider may be required to submit a biometric sample such as a voice sample or a fingerprint scan before receiving the media content from the provider. Furthermore, verification system 20 may identify a user requesting media content blindly (i.e., without information as to who the user is supposed to be) by finding the best match candidate in database 23 without knowledge of who the user claims to be. In other words, verification system 20 can be used to dynamically discover or establish the identity of the user. Alternatively, verification system 20 may authenticate a user requesting media content only with respect to knowledge of the user's claimed identity, so that biometric samples are compared to only with the stored biometric information corresponding to that identity.

Referring now to FIG. 3, with continual reference to FIG. 1, a flow diagram 40 describing a method of centralized biometric authentication of users requesting media content in accordance with the present invention is shown. The method initially begins with a user pre-registering with a provider by providing an initial biometric sample to the provider for storage in verification system 20 as shown in block 41. Verification system 20 stores the initial biometric sample as biometric information which identifies the user as shown in block 41.

The user then subsequently directs a media content presentation device (such as STB 12) to request media content from a provider (such as a TV provider) for the user as shown by block 42. The user may use an input device (such as remote control 18) or may manipulate the media content presentation device directly to communicate the request to the media content presentation device. The media content presentation device communicates the user's media content request through a communications network (such as TV network 14) to the provider as shown in block 44. The provider processes the media content request to identify the user and the media content requested by the user as shown in block 46. The provider determines whether the identity of the user has to be verified before the provider will deliver the requested media content to the media content presentation device for receipt by the user as shown in decision block 48.

If delivery of the media content from the provider to the user is contingent upon authentication of the user, then the provider directs the user to provide a biometric sample (such as a fingerprint) as shown in block 50. The provider communicates the biometric sample request through the communications network to the media content presentation device for receipt by the user. The user then provides the biometric sample to the media content presentation device (either directly or indirectly using an input device such as remote control 18) for receipt by the provider as shown in block 52. The media content presentation device then communicates a signal indicative of the biometric sample provided by the user through the communications network to the provider for receipt by verification system 20 as shown in block 54.

Verification system 20 then compares the biometric sample provided by the user with stored biometric information of the user to authenticate the identity of the user as shown in block 56. If the biometric sample provided by the user corresponds with the stored biometric information of the user, then verification system 20 provides a verification signal indicating authentication of the user to the provider as shown in block 58. Based on the user being authenticated as the user, the provider then delivers the media content requested by the user through the communications network to the media content presentation device for receipt by the user as shown in block 60.

In accordance with the various embodiments of the present invention, the pre-registered biometric information of a user requesting media content may be stored locally in the media content presentation device or the like instead of being stored by verification system 20. In this case, the media content presentation device compares a biometric sample received from the user with the locally stored biometric information of the user. If the comparison has a sufficient confidence level, then the media content presentation device advises the provider accordingly. In turn, the provider delivers the requested media content to the media content presentation device for receipt by the user.

In accordance with the various embodiments of the present invention, the media content requested by a user may already be stored in the media content presentation device. In this case, the provider has already delivered the media content to the media content presentation device before the user has requested access to the media content. The media content presentation device is configured to provide the media content to the user upon the user being authorized by the provider to receive the content and upon the identity of the user being verified. As such, the user communicates with the provider to obtain authorization for the media content. In response, the provider provides the user with an authorization code or the like. In turn, the user provides the authorization code and a biometric sample to the media content presentation device when requesting the media content from the media content presentation device. In response, the media content presentation device compares the biometric sample with the stored biometric information of the user. The media content presentation device then delivers the media content to the user if the biometric sample corresponds to the stored biometric information of the user.

In accordance with the various embodiments of the present invention, the present invention can be used in support of parental control technologies such as the “V-chip”. The present invention can also be expanded into digital rights management and other areas as well as media content would not be provided to a user unless the user is a purchaser, authorized recipient, or other individual entitled to receive the media content. The conditions of media content delivery are supported by the strong user identity claim that results when using one or more of the various biometric samples (e.g., fingerprint, fingerprint and voice, DNA, etc.) and provide much more protection than is currently provided.

In accordance with the various embodiments of the present invention, the methods described herein are intended for operation as software programs running on a computer processor. Dedicated hardware implementations including, but not limited to, application specific integrated circuits, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the present invention is considered to include a tangible storage medium or distribution medium, as listed herein and including art-recognized equivalents and successor media, in which the software implementations are stored.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A centralized biometric system for verifying the identity of a user over a communications network, the system comprising:
a storage that stores biometric information in association with information that identifies users;
a receiver that receives, from a media content presentation device via a communications network, a biometric sample provided by a user requesting media content from a provider, wherein the provider delivers the media content requested by the user from the communications network to the media content presentation device for receipt by the user contingent upon the identity of the user being verified; and
a processor that compares the biometric sample provided by the user to stored biometric information of the user, wherein the processor verifies the identity of the user upon a sufficient correspondence between the biometric sample provided by the user and the stored biometric information of the user.

2. The system of claim 1 wherein:
the receiver receives multiple media content requests from users accompanied with biometric samples of the users via multiple media content presentation devices that are each operable to provide media content delivered by providers to the users.

3. The system of claim 1 wherein:
the provider is a cable television provider, the media content presentation device is a set-top box, the communications network is a cable television network, and the media content is television programming.

4. The system of claim 1 wherein:
the provider is a satellite television provider, the media content presentation device is a set-top box, the communications network is a satellite television network, and the media content is television programming.

5. The system of claim 1 wherein:
the provider is a satellite radio provider, the media content presentation device is a set-top box, the communications network is a satellite radio network, and the media content is radio programming.

6. The system of claim 1 wherein:
the storage is remote from the media content presentation device.

7. The system of claim 1 wherein:
the storage is integrated into the media content presentation device.

8. The system of claim 1 wherein:
the media content presentation device is configured to receive the biometric sample provided by the user directly from the user.

9. The system of claim 1 wherein:
the media content presentation device is configured to receive the biometric sample provided by the user from an associated input device which is configured to receive the biometric sample directly from the user.

10. The system of claim 1 further comprising:
a log generator that generates a record of information relating to the verification of the identity of the user.

11. A method for verifying the identity of a user over a communications network using a centralized biometric system, the method comprising:
storing biometric information in association with information that identifies users;
receiving, from a media content presentation device via a communications network, a biometric sample provided by a user requesting media content from a provider, wherein the provider delivers the media content requested by the user from the communications network to the media content presentation device for receipt by the user contingent upon the identity of the user being verified;
comparing the biometric sample provided by the user to stored biometric information of the user; and
verifying the identity of the user upon a sufficient correspondence between the biometric sample provided by the user and the stored biometric information of the user.

12. The method of claim 11 wherein:
multiple media content requests from users accompanied with biometric samples of the users are received via multiple media content presentation devices that are each operable to provide media content delivered by providers to the users.

13. The method of claim 11 wherein:
the provider is a cable television provider, the media content presentation device is a set-top box, the communications network is a cable television network, and the media content is television programming.

14. The method of claim 11 wherein:
the provider is a satellite television provider, the media content presentation device is a set-top box, the communications network is a satellite television network, and the media content is television programming.

15. The method of claim 11 wherein:
the provider is a satellite radio provider, the media content presentation device is a set-top box, the communications network is a satellite radio network, and the media content is radio programming.

16. The method of claim 11 wherein:
the storage is remote from the media content presentation device.

17. The method of claim 11 wherein:
storing biometric information in association with information that identifies users includes storing the biometric information in the media content presentation device.

18. The method of claim 11 wherein:
the media content presentation device is configured to receive the biometric sample provided by the user directly from the user.

19. The method of claim 11 wherein:
the media content presentation device is configured to receive the biometric sample provided by the user from an associated input device which is configured to receive the biometric sample directly from the user.

20. A computer readable medium storing a program that verifies the identity of a user over a communications network using a centralized biometric system, the medium comprising:
a biometric storage code segment that stores biometric information in association with information that identifies users;
a receiving code segment that receives, from a media content presentation device via a communications network, a biometric sample provided by a user requesting media content from a provider, wherein the provider delivers the media content requested by the user from the communications network to the media content presentation device for receipt by the user contingent upon the identity of the user being verified; and
a comparing code segment that compares the biometric sample provided by the user to stored biometric information of the user, wherein the comparing code segment verifies the identity of the user upon a sufficient correspondence between the biometric sample provided by the user and the stored biometric information of the user.
